(19) United States
(12) Patent Application Publication
(10) Pub. No.: US 2019/0318278 A1
(43) Pub. Date: Oct. 17, 2019

(54) WORK MANAGEMENT METHOD, WORK MANAGEMENT PROGRAM, AND WORK MANAGEMENT APPARATUS

(71) Applicant: GURUNAVI, INC., Tokyo (JP)

(72) Inventor: Shinji KOKI, Tokyo (JP)

(73) Assignee: GURUNAVI, INC., Tokyo (JP)

(21) Appl. No.: 16/463,503

(22) PCT Filed: Oct. 27, 2017
(86) PCT No.: PCT/JP2017/038893

§ 371 Date: May 23, 2019

(30) Foreign Application Priority Data
Nov. 25, 2016 (JP) 2016-228918

(51) Int. Cl. G06Q 10/02; G06Q 10/06

(52) U.S. Cl. CPC G06Q 10/02; G06Q 10/063112; G06Q 10/063118

(57) ABSTRACT

[Problem] To provide a work management method, a work management program, and a work management apparatus that can reduce the time and effort of the staff of a facility.

[Solution to problem] A work management apparatus 2 according to the present invention includes: a reservation processing unit 211 configured to manage reservation information that indicates reservations made for a facility; and a notification processing unit 212 configured to notify, based on the reservation information, staff of the facility of a job that is to be done by the staff, at a predetermined notification timing that has been set in advance in correspondence with the job.

### TECHNICAL FIELD

The present invention relates to a work management method, a work management program, and a work management apparatus that support management of work of the staff of a facility.

### BACKGROUND ART

In general, in a facility such as a restaurant, the staff manages reservations of the facility by using a reservation table or the like, and in their daily work, the staff performs jobs by consulting the reservation table. It is noted that there is known a system configured to manage reservations of seats in a facility such as a restaurant (see, for example, PTL 1).

### CITATION LIST

### Patent Literature

[PTL 1] Japanese Patent Application Publication No. 2003-108839

### SUMMARY OF THE INVENTION

### Problems to be Solved by the Invention

However, the staff of a restaurant, in their daily work, needs to use their brains on how to manage the jobs in the restaurant, such as ushering a user to his/her seat when he/she visits the restaurant, changing the seat layout, and determining the timing for serving dishes of a course meal.

The present invention has been made in view of such conventional circumstances, and it is an object of the present invention to provide a work management method, a work management program, and a work management apparatus that can reduce the time and effort of the staff of a facility.

### Solution to the Problems

A work management apparatus according to an aspect of the present invention includes: a reservation processing unit configured to manage reservation information that indicates reservations made for a facility; and a notification processing unit configured to notify, based on the reservation information, staff of the facility of a job that is to be done by the staff, at a predetermined notification timing that has been set in advance in correspondence with the job.

A work management method according to another aspect of the present invention causes a computer to execute: a reservation step of managing reservation information that indicates reservations made for a facility; and a notification step of notifying, based on the reservation information, staff of the facility of a job that is to be done by the staff, at a predetermined notification timing that has been set in advance in correspondence with the job.

A work management program according to a further aspect of the present invention causes a computer to execute: a reservation step of managing reservation information that indicates reservations made for a facility; and a notification step of notifying, based on the reservation information, staff of the facility of a job that is to be done by the staff, at a predetermined notification timing that has been set in advance in correspondence with the job.

### Advantageous Effects of the Invention

According to the present invention, it is possible to provide a work management method, a work management program, and a work management apparatus that can reduce the time and effort of the staff of a facility.

### BRIEF DESCRIPTION OF THE DRAWINGS

FIG. 1 is a block diagram showing a configuration of a work management system according to an embodiment of the present invention.

FIG. 2 is a diagram showing an example of reservation information managed by a work management apparatus according to the embodiment of the present invention.

FIG. 3 is a diagram showing an example of a reservation table managed by the work management apparatus according to the embodiment of the present invention.

FIG. 4 is a flowchart showing an example of a work management process executed by the work management apparatus according to the embodiment of the present invention.

FIG. 5 is a flowchart showing an example of a job performance control process executed by the work management apparatus according to the embodiment of the present invention.

FIG. 6 is a diagram showing an example of a display screen displayed by the work management process executed by the work management apparatus according to the embodiment of the present invention.

FIG. 7 is a diagram showing an example of a display screen displayed by the work management process executed by the work management apparatus according to the embodiment of the present invention.

FIG. 8 is a diagram showing an example of a display screen displayed by the work management process executed by the work management apparatus according to the embodiment of the present invention.

FIG. 9 is a diagram showing an example of a display screen displayed by the work management process executed by the work management apparatus according to the embodiment of the present invention.

FIG. 10 is a flowchart showing an example of a reservation confirmation process executed by the work management apparatus according to the embodiment of the present invention.

### DESCRIPTION OF EMBODIMENTS

The following describes an embodiment of the present invention with reference to the accompanying drawings for the understanding of the invention. It should be noted that the following embodiment is an example of a specific embodiment of the present invention and should not limit the technical scope of the present invention.

[Work Management System 1]

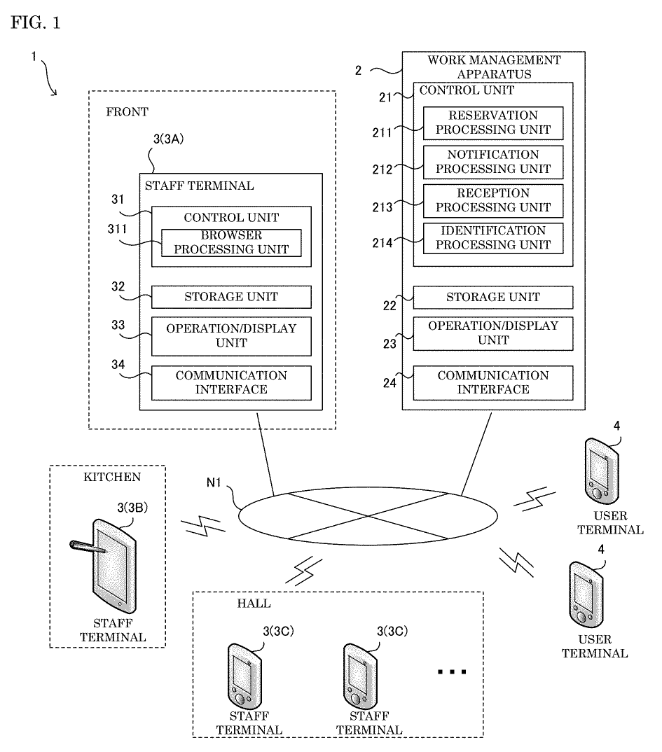

As shown in FIG. 1, a work management system 1 according to an embodiment of the present invention includes a work management apparatus 2, one or more staff terminals 3, and one or more user terminals 4. The work management apparatus 2, the staff terminals 3, and the user terminals 4 can communicate with each other via a communication network N1 that may be, for example, the Internet, a LAN, a WAN, or a public telephone line.

The work management system 1 is configured to support the work of staff members in a facility such as a restaurant. Specifically, in the work management system 1, as described below, the work management apparatus 2 manages reservations of the facility, and based on the content of reservations made, instructions are sent to the staff of the facility through the staff terminals 3 carried by the staff. It is noted that the work management apparatus 2 also manages the present situation of the seats in the facility (for example, how many seats are vacant).

The subjects for the management of the work management system 1 include a restaurant, an event facility, a hotel, or a golf course that can be used for various types of events such as a new year party, a year-end party, a barbecue, a party, a social gathering, a class reunion, a company trip, and a golf competition. The present embodiment describes an example case where the subject for the management is a restaurant.

In the present embodiment, the work management system 1 includes the work management apparatus 2 and the staff terminals 3. However, not limited to this configuration, the work management apparatus 2 may be a stand-alone system that serves as the staff terminals 3.

### [Work Management Apparatus 2]

As shown in FIG. 1, the work management apparatus 2 is a server computer that includes a control unit 21, a storage unit 22, an operation/display unit 23, and a communication interface 24. For example, although the work management apparatus 2 may be installed in the facility that is the subject for the management of the work management system 1, the work management apparatus 2 may be provided outside the facility in so far as it can communicate with the staff terminals 3 and the user terminals 4. It is noted that the work management apparatus 2 is not limited to be a computer, but may be a computer system in which a plurality of computers operate cooperatively with each other. In addition, various types of processes to be executed by the work management apparatus 2 may be distributed to and executed by one or more processors.

The communication interface 24 allows the work management apparatus 2 to be connected to the communication network N1 by wire or wirelessly and to execute a data communication with external apparatuses such as the staff terminals 3 and the user terminals 4 via the communication network N1 based on a predetermined communication protocol.

The operation/display unit 23 is a user interface including a display unit and an operation unit, wherein the display unit is, for example, a liquid crystal display or an organic EL display for displaying various types of information, and the operation unit is, for example, a mouse, a keyboard, or a touch panel for receiving operations.

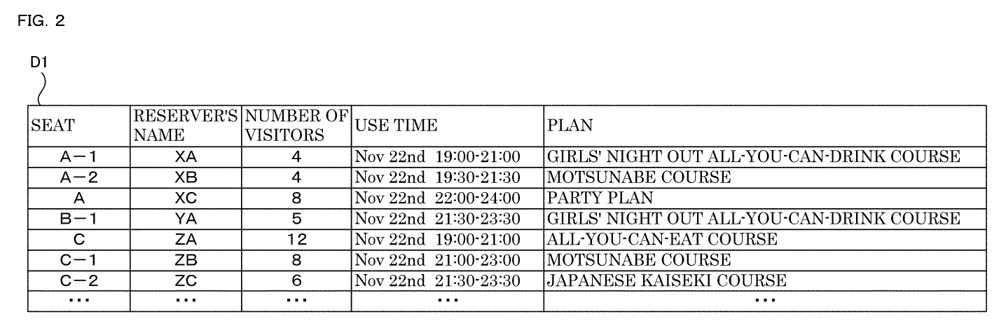

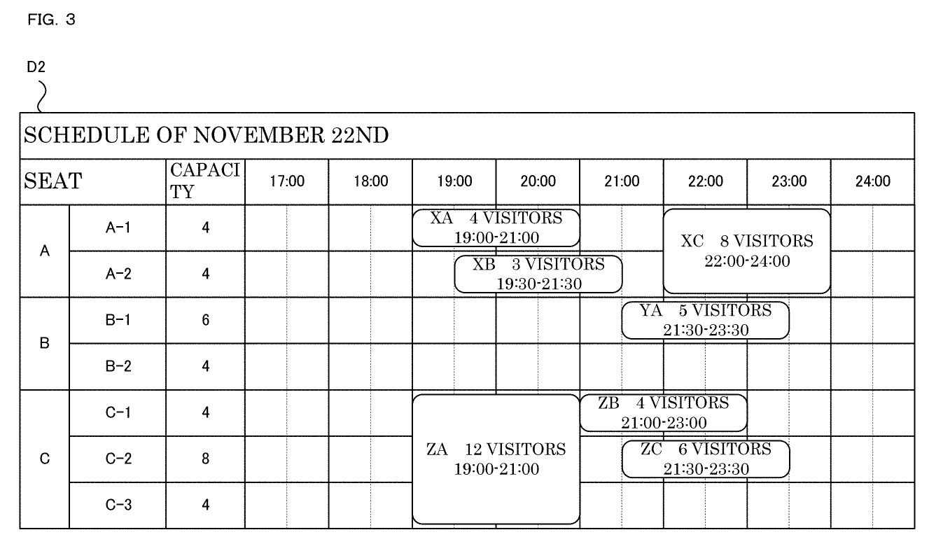

The storage unit 22 is a nonvolatile storage unit including, for example, a semiconductor memory, an HDD (Hard Disk Drive), or an SSD (Solid State Drive) for storing various types of information. Specifically, the storage unit 22 stores reservation information D1 and a reservation table D2. Here, FIG. 2 shows an example of the reservation information D1, and FIG. 3 shows an example of the reservation table D2.

As shown in FIG. 2, the reservation information D1 is composed of one or more pieces of information which each includes a seat for use, a reserver's name, the number of visitors, a use time, and a plan, as the content of a reservation. The plan is, for example, a course meal composed of a plurality of dishes. It is noted that information such as the number of seats in the facility, seat layouts, available forms of combination, separation, and movement of the seats, dishes for each plan, and a time schedule for each plan are set in advance and stored in the storage unit 22.

The reservation table D2 graphically shows the content of the reservation information D1 such that the staff of the facility can intuitively recognize the content of the reservation information D1. It is noted that the reservation information D1 is edited by a reservation processing unit 211, and the reservation table D2 is generated by the reservation processing unit 211.

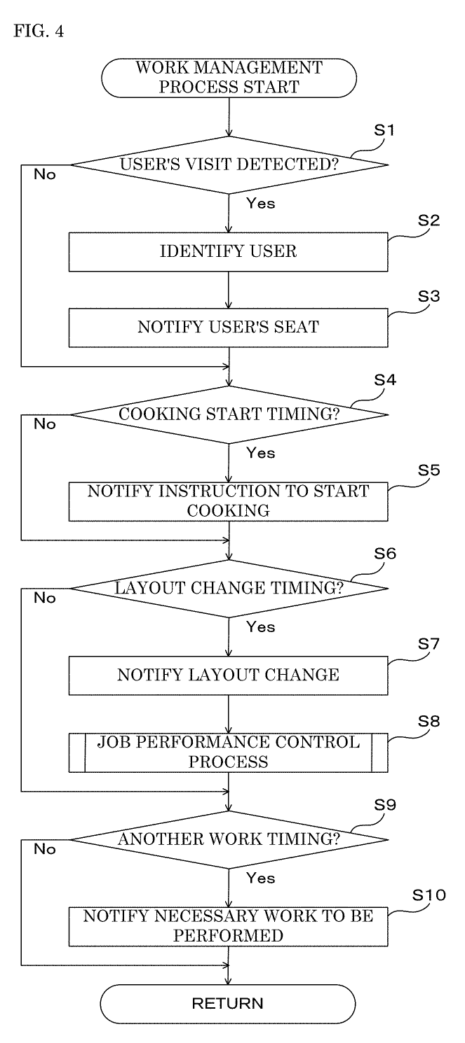

In addition, in another embodiment, a part or all of the information such as the reservation information D1 and the reservation table D2 may be stored in another server which can be accessed from the work management apparatus 2 via the communication network N1. In addition, the control unit 21 of the work management apparatus 2 may acquire various types of information from the server and execute processes such as a work management process (see FIG. 4) as described below.

Furthermore, the storage unit 22 stores control programs such as a work management program for causing the control unit 21 to execute the work management process (see FIG. 4) as described below. For example, the work management program is recorded in a non-transitory computer-readable recording medium such as a CD or a DVD, is read therefrom by a reading device (not shown) such as a CD drive or a DVD drive equipped in the work management apparatus 2, and is stored in the storage unit 22.

The control unit 21 includes control equipment such as a CPU, a ROM, and a RAM. The CPU is a processor for executing various types of calculation processes. The ROM is a nonvolatile storage unit in which control programs such as a BIOS or an OS for causing the CPU to execute various types of processes are stored in advance. The RAM is a volatile or nonvolatile storage unit that is used as a temporary storage memory (work area) for the various types of processes executed by the CPU. The control unit 21 controls the work management apparatus 2 by causing the CPU to execute the various types of control programs that have been stored in the ROM or the storage unit 22 in advance.

Specifically, as shown in FIG. 1, the control unit 21 includes various types of processing units such as a reservation processing unit 211, a notification processing unit 212, a reception processing unit 213, and an identification processing unit 214. It is noted that the control unit 21 functions as the various types of processing units by causing the CPU to execute various types of processes in accordance with the work management program. In addition, a part or all of the processing units included in the control unit 21 may be configured as an electronic circuit(s). It is noted that the work management program may be executed to cause a plurality of processors to function as the various types of processing units.

The reservation processing unit 211 is configured to execute a reservation step to manage the reservation information D1 that indicates the content of reservations for the facility. Specifically, the reservation processing unit 211 is configured to receive a reservation request from a staff member using the staff terminal 3, or a reservation request from a user using the user terminal 4, and automatically update the reservation information D1 based on the received reservation request and predetermined reservation rules. The process mentioned here is an example of the reservation step. For example, in response to an access from a staff terminal 3 or a user terminal 4, the reservation processing unit 211 displays a reservation screen for inputting content of the reservation on the staff terminal 3 or the user terminal 4. Subsequently, the reservation processing unit 211 receives a reservation request based on an operation of the staff member/user performed on the staff terminal 3/user terminal 4. It is noted that the reservation request may include a request received from a user who has visited the restaurant abruptly without reservation.

Upon receiving a reservation request, the reservation processing unit 211 determines, based on the reservation information D1, whether or not a reservation requested by the reservation request is acceptable, and if the reservation is acceptable, add a content of reservation corresponding to the reservation request to the reservation information D1. In particular, the reservation processing unit 211 selects a seat to be assigned to the user based on a seat assignment condition that has been set in advance as one of the reservation rules, and updates the reservation information D1. At this time, if it is determined based on the reservation information D1 that a combination, separation, or movement of the seats in the facility is required, the reservation processing unit 211 sets, in the reservation information D1, a seat layout including the combination, separation, or movement of the seats. If the seat layout is changed many times, the work load of the staff members is increased. As a result, for example, the seat assignment condition may be that a seat to be assigned should be selected such that the need for the seat layout change is reduced as much as possible. In addition, the reservation processing unit 211 is configured to receive a reservation cancellation request from a user, and upon receiving the reservation cancellation request, delete a content of reservation corresponding to the reservation cancellation request from the reservation information D1. Various types of conventional techniques can be used to realize such a function to automatically manage the reservation information D1, and detailed description thereof is omitted here. In the present embodiment, the reservation information D1 is automatically updated by the reservation processing unit 211. However, not limited to this configuration, the reservation processing unit 211 may edit the reservation information D1 arbitrarily based on operations performed on the staff terminals 3.

In addition, the reservation processing unit 211 is configured to generate the reservation table D2 based on the reservation information D1 in accordance with operations of a staff member performed on a staff terminal 3, and display the reservation table D2 on the staff terminal 3. Specifically, the reservation processing unit 211 updates the reservation table D2 when the reservation information D1 is updated, and stores the updated reservation table D2 in the storage unit 22, or upon receiving a request to display the reservation information D1, generates the reservation table D2 based on the reservation information D1, and display the generated reservation table D2. It is noted that as described below, in the work management apparatus 2, jobs that are to be done by the staff members and timings of doing the jobs are automatically notified. As a result, since there is no need to display the reservation table D2, in another embodiment, the reservation processing unit 211 may not have the function to display the reservation table D2.

The notification processing unit 212 executes a notification step to notify, based on the reservation information D1, the staff terminal(s) 3 or the user terminal(s) 4 of a job that is to be done by a staff member of a facility, at a notification timing that has been set in advance in correspondence with the job. Specifically, as described below, the notification processing unit 212 performs the notification at a notification timing such as when a user has visited the restaurant, when a dish should start to be cooked, and when the seat layout should be changed.

Here, the notification by the notification processing unit 212 to the staff terminals 3 is realized by a cooperation between an application installed in the work management apparatus 2 and applications installed in the staff terminals 3. It is noted that, for example, the notification by the notification processing unit 212 to the staff terminals 3 may be realized through e-mail or SNS. In addition, the notification by the notification processing unit 212 to the staff terminals 3 may be realized by a browser function. Furthermore, the notification by the notification processing unit 212 to the staff terminals 3 may be realized by a push notification using a browser function or the like.

In the present embodiment, the notification is realized by a message display. However, not limited to this, the notification may be realized by another method such as a voice/audio reproduction. For example, a headset including a microphone and a headphone may be connected to each of the staff terminals 3 by a short-range wireless communication such as Bluetooth (registered trademark) or wireline, the control unit 21 of each of the staff terminals 3 may be configured to receive a user operation by recognizing a voice/audio of a staff member sent via the headset, and the notification processing unit 212 may perform the notification by outputting voice/audio to the headset.

The reception processing unit 213 executes a process of, upon notification of a predetermined job from the notification processing unit 212, receiving, from a staff terminal(s) 3, an operation indicating whether or not the job can be done. Specifically, the reception processing unit 213 can determine whether or not the job can be executed, based on an operation signal that has been input by a staff member to a staff terminal 3 and transmitted from the staff terminal 3 to the work management apparatus 2.

The identification processing unit 214 executes a process to identify a user who has visited the facility. Specifically, the identification processing unit 214 identifies a user of a user terminal 4 based on check-in information that includes identification information such as a user's name or ID, wherein the check-in information is input to the work management apparatus 2 when the user performs a predetermined check-in operation on the user terminal 4 that is carried by the user. In addition, the work management apparatus 2 stores user information of users that were obtained through the users' operations performed on the user terminals 4, the user information including names of the users, IDs, telephone numbers for contact, and e-mail addresses for contact. Thus the work management apparatus 2 can identify contact information such as a telephone number or an e-mail address of each of the users. It is noted that, for example, when a user visits a facility, the user performs the check-in operation to register the user's visit to the facility. The check-in operation is received on a web page provided by the application installed in the user terminal 4 or a web page provided by the work management apparatus 2, and the check-in information is input to the work management apparatus 2.

It is noted that the user terminal 4 is not limited to a terminal carried by each of a plurality of users, but may be a terminal installed in the front so as to be used commonly by the users. In that case, the user terminal 4 may include an operation/display unit, such as a touch panel display, so as to display a message as a notification to the user and receive a touch operation of the user, or may be able to send a notification to the user by vocally reproducing a message and receive an operation by recognizing a voice of the user.

In addition, the method for identifying a user employed by the identification processing unit 214 is not limited to the check-in operation. For example, a visit of a user to a facility may be detected based on positional information of the user acquired based on the GPS installed in each of the user terminals 4, or a visit of a user to a facility may be detected based on transmissions/receptions of a beacon signal to/from the user terminals 4. In addition, a user may be identified based on information that is read by a bar code reader from a bar code or a QR code (registered trademark) printed on a reservation form that is printed when a user requests a reservation using the user terminal 4.

[Staff Terminal 3]

As shown in FIG. 1, each of the staff terminals 3 includes a control unit 31, a storage unit 32, an operation/display unit 33, and a communication interface 34. The staff terminal 3 is, for example, an information processing apparatus such as a mobile phone, a smartphone, a tablet terminal, or a personal computer, or is an operation terminal used by a staff member of a facility or a user. It is noted that the user terminals 4 can have the same configuration as the staff terminals 3, and description thereof is omitted here.

The staff terminals 3 are respectively disposed in the front, kitchen, and hall of a facility, or carried by staff members in charge of the front, kitchen, and hall. In the following description, the staff terminals 3 corresponding to the front, kitchen, and hall are respectively referred to as a staff terminal 3A, a staff terminal 3B, and a staff terminal 3C, and they are collectivly referred to as a staff terminal 3.

It is noted that each staff member logs in the work management apparatus 2 by inputting a staff ID and a password on a predetermined log-in page that can be browsed by the staff member on the staff terminal 3. This makes it possible for the control unit 21 of the work management apparatus 2 to identify a staff member who is logging in the staff terminal 3. In addition, each of the staff terminals 3 may be a mobile terminal such as a mobile phone or a smartphone personally owned by a staff member. In that case, the correspondence relationship between the staff members and the mobile terminals needs to be set in the work management apparatus 2 in advance.

The communication interface 34 is configured to connect its associated staff terminal 3 to the communication network N1 by wire or wirelessly to perform a data communication with external apparatuses such as the work management apparatus 2 via the communication network N1 based on a predetermined communication protocol.

The operation/display unit 33 is a user interface including a display unit and an operation unit, wherein the display unit is, for example, a liquid crystal display or an organic EL display for displaying various types of information such as web pages, and the operation unit is, for example, a mouse, a keyboard, or a touch panel for receiving operations.

The storage unit 32 is a nonvolatile storage unit such as a flash memory for storing various types of information. For example, the storage unit 32 stores a control program such as a browser program. Specifically, the browser program is a control program for causing the control unit 31 to execute a communication process with an external apparatus such as the work management apparatus 2 in accordance with a communication protocol such as the HTTP (Hypertext Transfer Protocol).

The control unit 31 includes control equipment such as a CPU, a ROM, and a RAM. The CPU is a processor for executing various types of calculation processes. The ROM is a nonvolatile storage unit in which control programs such as a BIOS or an OS for causing the CPU to execute various types of processes are stored in advance. The RAM is a volatile or nonvolatile storage unit that is used as a temporary storage memory (work area) for the various types of processes executed by the CPU. The control unit 31 controls its associated staff terminal 3 by causing the CPU to execute the various types of control programs that have been stored in the ROM or the storage unit 32 in advance.

Specifically, the control unit 31 functions as a browser processing unit 311 by executing various types of processes in accordance with the browser program stored in the storage unit 32. The browser processing unit 311 is configured to execute a browser process to display, on the operation/display unit 33, a web page that is provided from the work management apparatus 2 via the communication network N1, and input an operation performed on the operation/display unit 33 to the work management apparatus 2. It is noted that a part or all of the processing units included in the control unit 31 may be configured as an electronic circuit(s).

Meanwhile, the staff of a restaurant, in their daily work, needs to use their brains on how to manage the jobs in the restaurant, such as ushering a user to his/her seat when he/she visits the restaurant, changing the seat layout, and determining the timing for serving dishes of a course meal. On the other hand, according to the work management method executed by the work management system 1 of the present embodiment, it is possible to reduce the time and effort of the staff of a facility.

[Work Management Process]

The following describes the work management process executed by the control unit 21 of the work management apparatus 2. It is noted that the work management process may be terminated halfway by a predetermined operation performed on a staff terminal 3.

It is noted that the present invention may be regarded as an invention of a work management method which executes one or more steps included in the work management process, and one or more steps included in the work management process described here may be omitted as appropriate. The steps constituting the work management process may be executed in different orders as far as a same action effect is produced. In the following description, it is assumed that the steps constituting the work management process are executed by the control unit 21. However, in a work management method of another embodiment, the steps constituting the work management process may be executed in distribution by a plurality of processors.

<Step S1>

In step S1, the control unit 21 determines whether or not a user's visit to a facility has been detected. Specifically, the control unit 21 determines that a user's visit to the facility has been detected, when the user has performed the check-in operation on his/her user terminal 4. Here, when the control unit 21 determines that a user's visit to the facility has been detected (S1: Yes), the process moves to step S2; and when the control unit 21 determines that a user's visit to the facility has not been detected (S1; No), the process moves to step S4.

<Step S2>

In step S2, the control unit 21 executes a process to identify the user detected in step S1. As described above, the control unit 21 can identify the user based on the check-in information of the user, as one example. It is noted that the process of this step is executed by the identification processing unit 214.

<Step S3>

In step S3, the control unit 21 executes a notification step to identify a seat that is to be used by the user, based on the user identified in step S2 and the reservation information D1, and notify the identified seat. That is, a timing at which a user visits a facility is an example of the notification timing. Specifically, based on the reservation information D1, when a use time of the user identified in step S2 has come, or when a time period that is equal to or less than a predetermined time period remains until the use time, the control unit 21 notifies the seat to the staff terminal 3A in the front, or to the staff terminal 3C in the hall on the condition that the seat to be used by the user is vacant. It is noted that in a case where the seat to be used by the user is not vacant when the use time of the user identified in step S2 has come, or when a time period that is equal to or less than the predetermined time period remains until the use time, the control unit 21 may send a notification to the staff terminal 3A to instruct to urge a user who is currently using the seat to leave the facility.

Here, the control unit 21 may notify all the staff terminals 3A and 3C or may notify one or more staff terminals 3A or 3C that are selected from all the staff terminals 3A and 3C based on a predetermined priority condition. In addition, each staff member may be associated with one or more seats, and a staff terminal 3C of a staff member associated with a seat for guide may be selected as a notification destination.

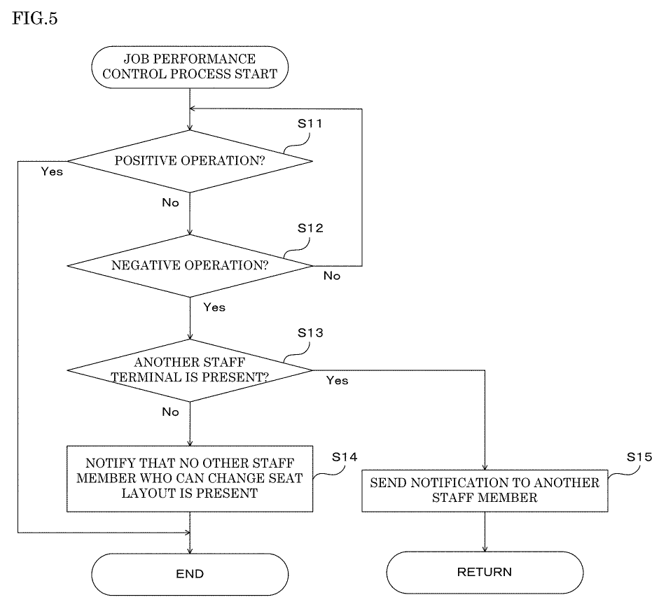

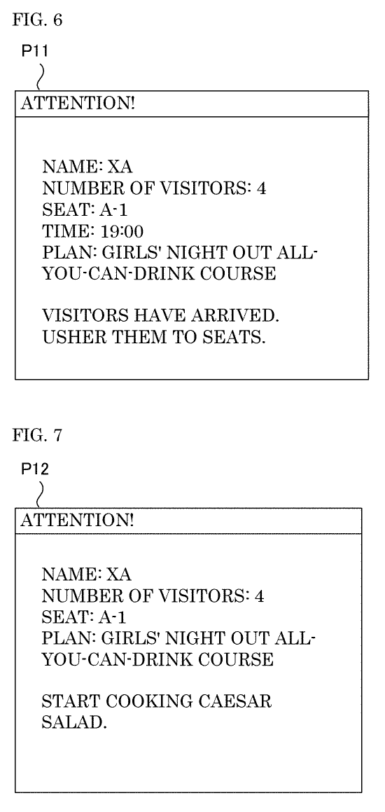

Here, FIG. 6 shows an example of a display screen P11 that is displayed on a staff terminal 3A in step S3. As shown in FIG. 6, the display screen P11 of the staff terminal 3A displays content of the reservation including the user's name (XA), the number of visitors (four), the seat (A-1), and the plan (girls' night out all-you-can-drink course), and a message urging to guide the user.

With the above-described configuration, staff members in the front or hall can easily guide the users by consulting the display screen P11 notified on the staff terminals 3A or 3C, without consulting a reservation table or the like to identify a seat to which a user is to be guided. This makes it possible to improve the work efficiency of the staff of a facility.

<Step S4>

In step S4, the control unit 21 determines whether or not a cooking start timing has come, to start cooking a dish to be served to a user who has visited the restaurant. Specifically, in a case where a predetermined course meal had been ordered by the user, it is possible to determine timings for serving dishes constituting the predetermined course meal, according to a predetermined time schedule. As a result, when a course meal is included in the reservation information D1 as the content of reservation, the control unit 21 may calculate the cooking start timing for a dish to be served to the user, based on a time schedule that had been set in advance in correspondence with the course meal and the visit date or use time of the user. In addition, when a menu item of arbitrary selection such as a la carte had been ordered by the user, the control unit 21 may determine the cooking start timing for each dish to be served to the user, based on a priority that had been set for each menu item in advance. Here, when it is determined that the cooking start timing has come (S4; Yes), the process moves to step S5; and when it is determined that the cooking start timing has not come (S4; No), the process moves to step S6.

<Step S5>

In step S5, the control unit 21 executes a notification step to, based on the reservation information D1, send a notification of an instruction to start cooking the dish for which it was determined in step S4 that the cooking start timing had come. Specifically, the control unit 21 notifies staff terminals 3B of staff members in the kitchen of, by displaying thereon, an instruction to start cooking a dish for which it was determined in step S4 that the cooking start timing had come, among the dishes included in the plan of the user. That is, the cooking start timing is an example of the notification timing, and the control unit 21 notifies the staff terminals 3B of an instruction to start cooking a dish each time the cooking start timing comes.

Here, FIG. 7 shows an example of a display screen P12 that is displayed on a staff terminal 3B in step S5. As shown in FIG. 7, the display screen P12 of the staff terminal 3B displays content of the reservation including the user's name (XA), the number of visitors (four), the seat (A-1), and the plan (girls' night out all-you-can-drink course), and a message urging to start cooking a dish (Caesar salad) included in the plan. It is noted that when the reservation information D1 includes another information such as allergy of the user, the control unit 21 may notify the other information when notifying the cooking start timing.

With the above-described configuration, staff members in the kitchen can determine the cooking start timings of the dishes by consulting the display screen P12 notified on the staff terminals 3B, without consulting a reservation table or the like. This improves the work efficiency of the staff of a facility. In addition, it may be configured such that when the user operates the user terminal 4 to request serving the next dish, the user terminal 4 transmits a cooking start request to the work management apparatus 2, and upon receiving the cooking start request, the control unit 21 determines that the cooking start timing has come.

<Step S6>

In step S6, the control unit 21 determines whether or not a seat layout change timing to change the seat layout of the facility has come. Specifically, the control unit 21 determines, based on the reservation information D1, whether or not a predetermined preparation start time has come, wherein the preparation start time is set to be slightly earlier than (for example, five or ten minutes before) a use start time of the user. Upon determining that the preparation start time has come, the control unit 21 determines whether or not the layout of the seat to be used by the user needs to be changed, and upon determining that the seat layout needs to be changed, the control unit 21 determines that the seat layout change timing has come. Here, when the control unit 21 determines that the seat layout change timing has come (S6; Yes), the process moves to step S7; and when the control unit 21 determines that the seat layout change timing has not come (S6; No), the process moves to step S9.

<Step S7>

In step S7, the control unit 21 executes a notification step to notify, based on the reservation information D1, how to change the layout of the seat for which it was determined in step S6 that the seat layout change timing had come. That is, the seat layout change timing is an example of the notification timing. Specifically, the control unit 21 sends, and displays, a schematic image or a message indicating seat layouts before and after a change of the seat, for which it was determined in step S6 that the seat layout change timing had come, to the staff terminal 3C in the hall. For example, changing the seat layout includes combining, separating, and moving a seat(s).

Here, the control unit 21 may send the notification to all the staff terminals 3C or to one or more staff terminals 3C that are selected from all the staff terminals 3C based on a predetermined priority condition. In addition, each staff member may be associated with one or more seats, and a staff terminal 3C of a staff member associated with a seat for layout change may be selected as a notification destination.

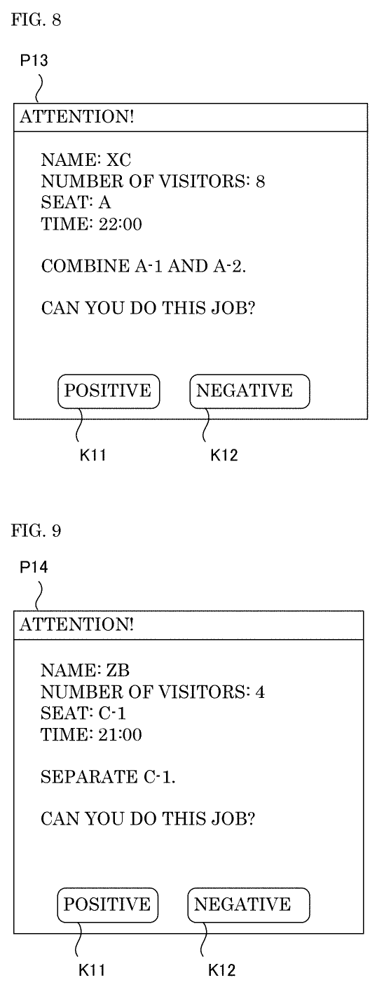

Here, FIG. 8 shows an example of a display screen P13 that is displayed on a staff terminal 3C in step S6. As shown in FIG. 8, the display screen P13 of the staff terminal 3C displays content of the reservation including the user's name (XA), the number of visitors (eight), the seat (A), and the time (22:00), and a message showing how to change and urging to change the seat layout (combine A-1 and A-2). For example, in a case where seats A-1 and A-2 respectively for four visitors have been used separately and now the seats A-1 and A-2 are to be used for eight visitors, the staff members are urged to combine the seats A-1 and A-2.

Here, FIG. 9 shows an example of a display screen P14 that is displayed on a staff terminal 3C in step S6. As shown in FIG. 9, the display screen P14 of the staff terminal 3C displays content of the reservation including the user's name (ZB), the number of visitors (four), the seat (C-1), and the time (21:00), and a message showing how to change and urging to change the seat layout (separate C-1). For example, in a case where seats C-1 to C-3 have been used in a combined form for 12 visitors and now the seat C-1 is to be used for four visitors, the staff members are urged to separate the seat C-1.

With the above-described configuration, staff members in the hall can recognize whether the seat layout needs to be changed, how to change it, the change timing and the like by consulting the display screen P13 or P14 notified on the staff terminals 3C, without consulting a reservation table or the like. This improves the work efficiency of the staff of a facility.

<Step S8>

In step S8, the control unit 21 executes a job performance control process in which to execute a process depending on whether a staff member carrying a staff terminal 3 that received the notification sent in step S7, can change the seat layout as urged by the notification. The job performance control process is described in detail below. It is noted that the execution of the job performance control process is not limited to the timing when the notification to change the seat layout is sent, but may be executed at the timing when a notification of a user's visit is sent or when a notification to start cooking is sent.

<Steps S9 to S10>

In steps S9 to S10, the control unit 21 determines whether or not another work timing other than the above-described work timings has come (S9), and upon determining that another work timing has come, notifies the staff terminals 3 of a job corresponding to the other work timing (S10). For example, when a work timing to take the last order from the user has come, the control unit 21 may notify the staff terminals 3 of the fact. In addition, the control unit 21 may determine whether or not a work timing to urge a user to leave the facility has come, and notify the staff terminals 3 of the determination result. Furthermore, when a predetermined work timing to purchase ingredients for a reservation has come, the control unit 21 may determine an amount of necessary ingredients based on the reservation information D1 for a day having the reservation, and notify the staff terminals 3 of the amount of the necessary ingredients, wherein the work timing is set to be within the day having the reservation, or a day before the day having the reservation. Furthermore, for example, when the specified plan is a pot dish course, the control unit 21 may send the staff terminals 3 a notification urging to prepare a pot set at a predetermined work timing slightly earlier than a use time of a user of the plan.

As described above, the work management apparatus 2 automatically notifies the staff members of various jobs to be done, at appropriate timings based on the reservation information D1 and the like. This eliminates the need for the staff members to use their brains on how to manage the works in the facility by consulting the reservation table D2 or the like, thereby reducing the time and effort of the staff members. In particular, since the work management apparatus 2 notifies a predetermined staff terminal(s) 3 that is selected from all the staff terminals 3 based on the content of the job, the staff members refer to only necessary information efficiently. For example, when a user visits the facility, a notification is sent only to a staff terminal(s) 3A in the front; when cooking should be started, a notification is sent only to a staff terminal(s) 3B in the kitchen; and when the seat layout should be changed, a notification is sent to a staff terminal(s) 3C in the hall.

Furthermore, as described above, in a case where the work management apparatus 2 has an automatic seat assignment function to automatically assign a seat in response to a reservation request from a user or a staff member, it is possible to eliminate the time and effort of the staff members to assign a seat, and the time and effort of the staff members to perform an operation inside the facility in their daily work. This further improves the work efficiency of the staff. In addition, in the work management apparatus 2, the reservation table D2 may not be displayed. With such a configuration, the control unit 21 does not need to generate the reservation table D2 based on the reservation information D1 and store the reservation table D2 in the storage unit 22. This reduces the storage capacity required for the storage unit 22, and improves the use efficiency of the RAM by the control unit 21. In addition, since only a job is notified according to the configuration of the present embodiment, the amount of data communication is restricted in the present embodiment, and the processing is executed at a higher speed than in a case where the reservation table D2 is displayed on each of the staff terminals 3, for example.

[Job Performance Control Process]

Next, an example of the job performance control process executed in step S8 is described with reference to FIG. 5.

<Step S11>

In step S11, the control unit 21 determines whether or not a positive operation has been performed on a staff terminal 3C in response to the notification urging to change the seat layout. Specifically, in the staff terminal 3, the notification urging to change the seat layout and an operation key K11 (see FIG. 8) that is operated to indicate that changing the seat layout can be done, are displayed on the operation/display unit 33 by the control unit 31. When the operation key K11 is operated, the control unit 31 determines that changing the seat layout can be done. When the control unit 21 determines that the positive operation has been performed (S11: Yes), the job performance control process ends, and when the control unit 21 determines that positive operation has not been performed d (S11: No), the process moves to step S12.

<Step S12>

In step S12, the control unit 21 determines whether or not a negative operation has been performed on a staff terminal 3C in response to the notification urging to change the seat layout. Specifically, in the staff terminal 3, a notification urging to change the seat layout and an operation key K12 (see FIG. 8) that is operated to indicate that changing the seat layout cannot be done, are displayed on the operation/display unit 33 by the control unit 31. When the operation key K12 is operated, the control unit 31 determines that changing the seat layout cannot be done. When the control unit 21 determines that the negative operation has been performed (S12: Yes), the process moves to step S13, and when the control unit 21 determines that the positive operation has not been performed (S12: No), the process returns to step S11.

In addition, in step S12, if any confirmation operation such as the positive operation had not been performed by a staff member on a staff terminal 3 before a predetermined wait time elapsed after the notification urging to change the seat layout had been received, the control unit 21 may move the process to step S13 as when the negative operation had been performed. With this configuration, even in a case where a staff member is occupied in another job and cannot operate the staff terminal 3C, the job is notified to a staff terminal 3C that is different from the staff terminal 3C that had already received the notification to change the seat layout.

<Step S13>

In step S13, the control unit 21 determines whether or not another staff terminal(s) 3C other than a staff terminal(s) 3C that had received the notification urging to change the seat layout, is present in the hall. Here, when the control unit 21 determines that another staff terminal 3C is present (S13: Yes), the process moves to step S15; and when the control unit 21 determines that another staff terminal 3C is not present (S13: No), the process moves to step S14.

<Step S14>

In step S14, the control unit 21 notifies the staff terminal(s) 3C that received the notification urging to change the seat layout, that no other staff member who can change the seat layout is present. It is noted that in step S14, the control unit 21 may notify only a staff terminal(s) 3C that immediately before received the notification urging to change the seat layout, that no other staff member who can change the seat layout is present. In another embodiment, in step S14, the control unit 21 may notify each of staff terminals 3C that received the notification urging to change the seat layout, that no other staff member who can change the seat layout is present. In addition, when a predetermined time period has elapsed since the notification in step S14, the control unit 21 may re-execute the notification of a job such as changing the seat layout.

<Step S15>

In step S15, the control unit 21 sends the notification urging to change the seat layout to one or more staff terminals 3 that are different from the staff terminal(s) 3C that received the notification in step S7. With this configuration, when a staff member(s) who received the notification urging to change the seat layout, cannot change the seat layout, the same notification is sent to the other staff terminals 3C, and it is expected that the other staff members can change the seat layout. This improves the work efficiency of the staff of a facility.

Meanwhile, according to the present embodiment, in step S3, a seat assigned to a user is notified to a staff terminal(s) 3A. On the other hand, in step S3, the control unit 21 may notify a seat assigned to a user who has checked in the facility, to the user terminal 4 of the user. This allows the user to recognize his/her seat and move to the seat by himself/herself, thereby reducing the work load of the staff of the facility. In addition, as a method for notifying a user of his/her seat, the control unit 21 may illuminate a series of light emitting bodies such as LEDs arranged to extend from the front to the user's seat, among a plurality of series of light emitting bodies arranged to extend from the front to each of the plurality of seats.

In addition, when the control unit 21 send a notification to start cooking in step S5, the control unit 21 may notify the fact that the cooking is started, to the user terminal 4 of the user. This allows the user to recognize a start of cooking each time a dish is cooked. Furthermore, in step S10, the control unit 21 may notify the user terminal 4 that a time for the last order has come, or that a time to leave the facility has come. With this configuration, since such items are directly notified to the user, the time and effort of the staff of the facility are further reduced.

In the present embodiment, a plurality of staff terminals 3 are provided. However, in another embodiment, a single staff terminal 3 may be provided in the work management system 1. Specifically, in steps S3, S5, S7 and S10 of the work management process of the present embodiment, the notifications may be sent to the single staff terminal 3, and step S8 may be omitted. For example, the single staff terminal 3 is one of the staff terminals 3A, 3B and 3C that are consulted by the staff members in the front, kitchen and hall. This allows a work manager of the facility to consult the information notified and displayed on the single staff terminal 3, and, for example, send instructions to other staff members. In addition, for example, the work management system 1 may be configured such that one staff terminal 3 is provided in each of the front, kitchen and hall, for each of a plurality of work types. It is noted that when a single staff terminal 3 is provided in the work management system 1, all notifications can be sent to the single staff terminal 3. On the other hand, when a plurality of staff terminals 3 are provided in the work management system 1, it is necessary to set a notification destination for each a plurality of jobs in advance. Accordingly, the control unit 21 may be configured to set a staff member or a staff terminal 3 arbitrarily as a notification destination for each job in accordance with a user operation performed on the work management apparatus 2 or the staff terminal 3.

[Reservation Control Process]

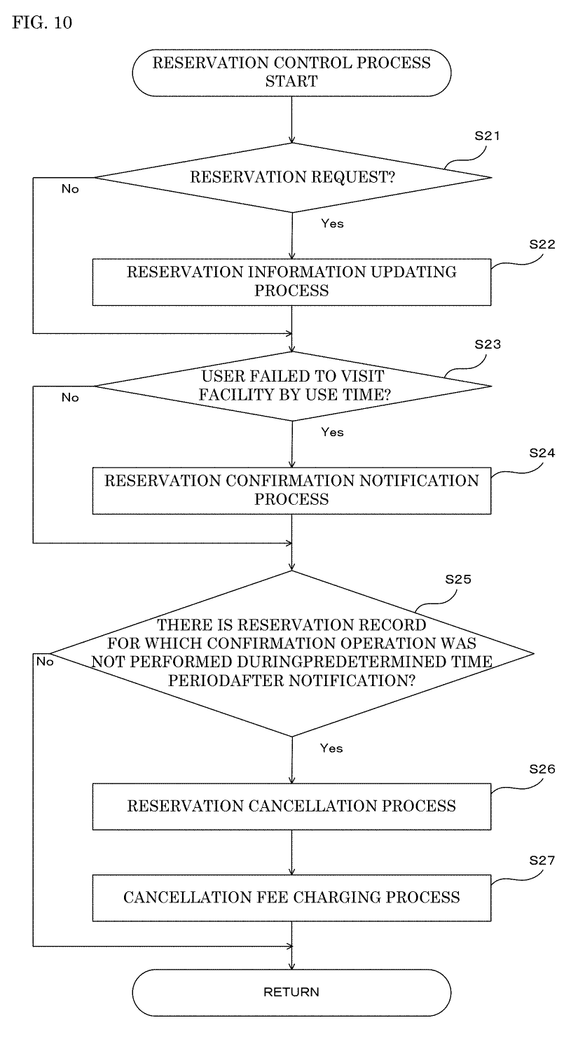

The control unit 21 executes a reservation control process based on the reservation information D1 and the visiting situation of the user. The control unit 21 executes the reservation control process approximately in parallel with the work management process. Here, FIG. 10 is a flowchart showing an example of the reservation control process. It is noted that the reservation control process is executed by the reservation processing unit 211 of the control unit 21.

<Step S21>

In step S21, the control unit 21 determines whether or not a reservation request has been made by a staff member or a user from a staff terminal 3 or a user terminal 4. When the control unit 21 determines that a reservation request has been made (S21: Yes), the process moves to step S22; and when the control unit 21 determines that a reservation request has not been made (S21: No), the process moves to step S23.

<Step S22>

In step S22, the control unit 21 executes a reservation information updating process to update the reservation information D1 based on the reservation request and the reservation information D1. Specifically, as described above, the control unit 21 determines, based on the reservation information D1, whether or not a reservation requested by the reservation request is acceptable, and if the reservation is acceptable, adds a content of reservation corresponding to the reservation request to the reservation information D 1. It is noted that the reservation request includes a new reservation request, a reservation change request, and a reservation cancellation request. For example, upon receiving a reservation cancellation request from a user, the control unit 21 deletes a content of reservation corresponding to the reservation cancellation request from the reservation information D1. In addition, upon receiving a reservation change request from a user, the control unit 21 determines whether or not a reservation corresponding to the reservation change request is acceptable, and if the reservation is acceptable, changes the reservation information D1.

<Step S23>

In step S23, the control unit 21 determines, based on the reservation information D1, whether or not there is a user who has failed to visit the facility by the use time. Specifically, the control unit 21 accepts a visit of each user in response to a check-in operation of the user, and records, for each reservation record included in the reservation information D1, whether or not a user visited the facility. This enables the control unit 21 to determine whether or not a user has failed to visit the facility by the use time indicated by the reservation information D 1. Here, when the control unit 21 determines that a user has failed to visit the facility by the use time (S23: Yes), the process moves to step S24; and when the control unit 21 to determine that a user has visited the facility by the use time (S23: No), the reservation control process ends. In this example, it is determined whether or not a user has failed to visit the facility by the use time. However, it may be determined whether or not a user has failed to visit the facility by a predetermined confirmation time that is set based on the use time, the confirmation time being, for example, a time point that precedes the use time by a predetermined time period (for example, five or ten minutes before the use time).

<Step S24>

In step S24, the control unit 21 executes a reservation confirmation notification process to notify the user who was determined to have failed to visit the facility by the use time in step S23, of the content of reservation including at least the use time among a plurality of items included in the reservation information D1. The content of reservation notified in the reservation confirmation notification process includes a use time, a user's name, a name of the facility to be used, the number of visitors, or a plan recorded in the reservation information D1 in correspondence with the user. Specifically, the control unit 21 calls, via a telephone line, a user's telephone number registered as the user information of the user, and notifies the content of reservation via an automatic audio assist. Alternatively, the control unit 21 may notify the content of reservation by executing an e-mail transmission process via the communication network N1 to a user's e-mail address that is registered as the user information of the user. This allows the content of reservation to be automatically notified to the user, thereby allowing the staff of the facility to omit confirming whether or not each user has visited the facility by the use time, and omit contacting the user who has not visited the facility by the use time.

In another embodiment, in step S24, the control unit 21 may execute a reservation confirmation notification process to notify the content of reservation of the user who was determined to have failed to visit the facility by the use time in step S23, to the staff of the facility based on the user information of the user. Specifically, the control unit 21 may display an indication that a user has not visited the facility by the use time, and the telephone number of the user for contact (e-mail address for contact) on, for example, a staff terminal 3A installed in the front among the plurality of staff terminals 3, urging a staff member to contact the user for confirmation of the content of reservation. With this configuration, although the staff of the facility needs to contact the user, it is not necessary for them to confirm whether or not each user has visited the facility by the use time. It is noted that in step S24, the control unit 21 may notify the content of reservation of the user who was determined to have failed to visit the facility by the use time in step S23, to the user and each of the staff members based on the user information of the user.

<Step S25>

Next, in step S25, the control unit 21 determines whether or not there is, among reservation records which are included in the reservation information D1 and for which the reservation confirmation notification process was executed in step S24, a reservation record for which a reservation confirmation operation had not been performed during a predetermined time period after the notification performed during the reservation confirmation notification process.

Specifically, in a case where the user had performed an operation on the user terminal 4 to indicate that he/she would visit the facility as scheduled, for a reservation record for which the reservation confirmation notification process was executed, the control unit 21 determines that the reservation confirmation operation was performed, based on an operation signal input from the user terminal 4 to the work management apparatus 2. In addition, in a case where a staff member had performed an operation on a staff terminal 3 to indicate that the user would visit the facility as scheduled, for a reservation record for which the reservation confirmation notification process was executed, the control unit 21 determines that the reservation confirmation operation was performed, based on an operation signal input from the user terminal 4 to the work management apparatus 2.

Here, when the control unit 21 determines that there is a reservation record for which a reservation confirmation operation had not been performed (S25: Yes), the process moves to step S26; and when the control unit 21 determines that there is no reservation record for which a reservation confirmation operation had not been performed (S25: No), the reservation confirmation notification process ends. It is noted that in a case where a cancellation operation had been performed for the reservation record on a staff terminal 3 or a user terminal 4, the process may move to step S26.

<Step S26>

In step S26, the control unit 21 executes a reservation cancellation process to cancel the reservation record for which the reservation confirmation operation had not been performed during the predetermined time period, which was identified in step S25. Specifically, the control unit 21 sets the seat and use time corresponding to the reservation record as vacant by automatically deleting the reservation record from the reservation information D1. This allows the reservation processing unit 211 of the control unit 21 to permit another user to use the seat during the use time corresponding to the cancelled reservation record.

<Step S27>

In step S27, the control unit 21 executes a process to charge a cancellation fee to the user with regard to the reservation record for which the reservation confirmation operation had not been performed during the predetermined time period, which was identified in step S25. Specifically, the control unit 21 may transmit, via e-mail, a message for payment of the cancellation fee to the user's e-mail address. This allows, for example, for the user to pay the cancellation fee through a credit card or bank transfer in accordance with the message. This allows the staff of the facility to omit the work of requesting the user to pay the cancellation fee.

As described above, with the work management process and the reservation control process executed in the work management apparatus 2, the time and effort of the staff of the facility are reduced with regard to a series of jobs starting from a reception of a reservation request from a user to a visit of the user, or a cancellation of the reservation. This makes it possible to improve the work efficiency of the facility.

[Statement of Invention]

The following states technical concepts of the invention extracted from the above-described embodiment. It is noted that the configurations and processing functions described in the following statement may be removed or combined in an arbitrary manner.

<Statement 1>

A work management apparatus comprising:

a reservation processing unit configured to manage reservation information that indicates reservations made for a facility; and

a notification processing unit configured to notify, based on the reservation information, staff of the facility of a job that is to be done by the staff, at a predetermined notification timing that has been set in advance in correspondence with the job.

<Statement 2>

The work management apparatus according to statement 1, wherein the reservation processing unit is configured to receive a reservation request from a user or the staff, and automatically update the reservation information based on the reservation request and predetermined reservation rules.

<Statement 3>

The work management apparatus according to statement 2, wherein

the reservation processing unit is configured to set, according to the reservation request, a seat layout including combining, separating, and moving one or more seats in the facility, and

the notification processing unit is configured to notify, as the job, the seat layout set by the reservation processing unit.

<Statement 4>

The work management apparatus according to any one of statements 1 to 3, further comprising:

an identification processing unit configured to identify a user who has visited the facility, wherein

the notification processing unit notifies a seat corresponding to the user, based on the user identified by the user identification process and the reservation information.

<Statement 5>

The work management apparatus according to any one of statements 1 to 4, wherein

the notification processing unit displays the job on predetermined one or more staff terminals

<Statement 6>

The work management apparatus according to any one of statements 1 to 4, wherein

the notification processing unit notifies the job to one or more staff terminals that are respectively associated with one or more staff members, the one or more staff terminals being selected in correspondence with the job from a plurality of staff terminals that are respectively associated with a plurality of staff members who constitute the staff.

<Statement 7>

The work management apparatus according to statement 6, further comprising:

a reception processing unit configured to receive operations including a negative operation from the one or more staff terminals to which the job was notified, the negative operation indicating that the one or more staff members cannot do the job, wherein

in a case where the reception processing unit has received the negative operation, the notification processing unit notifies the job to a staff terminal that is different from the one or more staff terminals.

<Statement 8>

The work management apparatus according to statement 6 or 7, wherein

in a case where any confirmation operation is not performed with regard to the job by the one or more staff members on the one or more staff terminals before a predetermined time elapses after a notification of the job to the one or more staff terminals, the notification processing unit notifies the job to a staff terminal that is different from the one or more staff terminals.

<Statement 9>

The work management apparatus according to any one of statements 1 to 8, wherein

in a case where the reservation information includes a predetermined course meal composed of a plurality of dishes, the notification processing unit calculates a cooking start timing for each of the plurality of dishes based on a time schedule that is set in advance in correspondence with the course meal, and notifies a predetermined staff terminal of an instruction to start cooking a dish each time the cooking start timing comes.

<Statement 10>

The work management apparatus according to any one of statements 1 to 9, wherein

in a case where a user has not visited the facility by a predetermined confirmation time that is set based on a use time indicated in the reservation information, the reservation processing unit notifies a content of reservation of the user, to at least one of the user or the staff.

<Statement 11>

The work management apparatus according to statement 10, wherein

in a case where a reservation confirmation operation is not performed during a predetermined time period after the reservation processing unit notifies the content of reservation, the reservation processing unit deletes a reservation record corresponding to the content of reservation from the reservation information.

<Statement 12>

A work management method for executing by a computer:

a reservation step of managing reservation information that indicates reservations made for a facility; and

a notification step of notifying, based on the reservation information, staff of the facility of a job that is to be done by the staff, at a predetermined notification timing that has been set in advance in correspondence with the job.

<Statement 13>

A work management program for causing a computer to execute:

a reservation step of managing reservation information that indicates reservations made for a facility; and

a notification step of notifying, based on the reservation information, staff of the facility of a job that is to be done by the staff, at a predetermined notification timing that has been set in advance in correspondence with the job.

### REFERENCE SIGNS LIST

1 work management system

2 work management apparatus

21 control unit

211 reservation processing unit

212 notification processing unit

213 reception processing unit

214 identification processing unit

3 staff terminal

4 user terminal

1.-13. (canceled)

14. A work management apparatus comprising:
a reservation processing unit configured to manage reservation information that indicates reservations made for a facility; and
a notification processing unit configured to notify, based on the reservation information, staff of the facility of a plurality of jobs that are to be done by the staff, at a plurality of notification timings that have been set in advance in correspondence with the plurality of jobs, wherein
the reservation processing unit is configured to receive a reservation request from a user or the staff, and automatically update the reservation information based on the reservation request and predetermined reservation rules, and automatically set, according to the reservation request, a seat layout including combining, separating, and moving one or more seats in the facility, and
the notification processing unit is configured to notify, as one of the jobs, the seat layout set by the reservation processing unit.

15. (canceled)

16. (canceled)

17. The work management apparatus according to claim 14, further comprising:
an identification processing unit configured to identify a user who has visited the facility, wherein
the notification processing unit notifies a seat corresponding to the user, based on the user identified by the identification processing unit and the reservation information.

18. (canceled)

19. The work management apparatus according to claim 14, wherein
the notification processing unit notifies the plurality of jobs to one or more staff terminals that are respectively associated with one or more staff members, the one or more staff terminals being selected in correspondence with the plurality of jobs from a plurality of staff terminals that are respectively associated with a plurality of staff members who constitute the staff.

20. The work management apparatus according to claim 19, further comprising:
a reception processing unit configured to receive operations including a negative operation from the one or more staff terminals to which the job was notified, the negative operation indicating that the one or more staff members cannot do the job, wherein
in a case where the reception processing unit has received the negative operation, the notification processing unit notifies the job to a staff terminal that is different from the one or more staff terminals.

21. The work management apparatus according to claim 19, wherein
in a case where any confirmation operation is not performed with regard to the job by the one or more staff members on the one or more staff terminals before a predetermined time elapses after a notification of the job to the one or more staff terminals, the notification processing unit notifies the job to a staff terminal that is different from the one or more staff terminals.

22. The work management apparatus according to claim 14, wherein
in a case where the reservation information includes a predetermined course meal composed of a plurality of dishes, the notification processing unit calculates a cooking start timing for each of the plurality of dishes based on a time schedule that is set in advance in correspondence with the course meal, and notifies a predetermined staff terminal of an instruction to start cooking a dish each time the cooking start timing comes.

23. The work management apparatus according to claim 14, wherein
in a case where a user has not visited the facility by a predetermined confirmation time that is set based on a use time indicated in the reservation information, the reservation processing unit notifies a content of reservation of the user, to at least one of the user or the staff.

24. The work management apparatus according to claim 23, wherein
in a case where a reservation confirmation operation is not performed during a predetermined time period after the reservation processing unit notifies the content of reservation, the reservation processing unit deletes a reservation record corresponding to the content of reservation from the reservation information.

25. A work management method for causing a computer to execute:
a reservation step of managing reservation information that indicates reservations made for a facility; and
a notification step of notifying, based on the reservation information, staff of the facility of a plurality of jobs that are to be done by the staff, at a plurality of notification timings that have been set in advance in correspondence with the plurality of jobs, wherein
the reservation step receives a reservation request from a user or the staff, and automatically updates the reservation information based on the reservation request and predetermined reservation rules, and automatically sets, according to the reservation request, a seat layout including combining, separating, and moving one or more seats in the facility, and
the notification step notifies, as one of the jobs, the seat layout set by the reservation step.

26. A non-transitory computer-readable recording medium storing a work management program for causing a computer to execute:
a reservation step of managing reservation information that indicates reservations made for a facility; and
a notification step of notifying, based on the reservation information, staff of the facility of a plurality of jobs that are to be done by the staff, at a plurality of notification timings that have been set in advance in correspondence with the plurality of jobs, wherein
the reservation step receives a reservation request from a user or the staff, and automatically updates the reservation information based on the reservation request and predetermined reservation rules, and automatically sets, according to the reservation request, a seat layout including combining, separating, and moving one or more seats in the facility, and
the notification step notifies, as one of the jobs, the seat layout set by the reservation step.
